(19) United States
(12) Patent Application Publication
(10) Pub. No.: US 2026/0104274 A1
(43) Pub. Date: Apr. 16, 2026

(54) METHOD AND DEVICE FOR DETERMINING AT LEAST ONE CORRECTIVE VALUE FOR AN ACTUAL PHASE VALUE TO BE CORRECTED AND ALSO FOR DETERMINING A RESULTING PHASE VALUE

(71) Applicant: Fraunhofer-Gesellschaft zur Förderung der angewandten Forschung e.V., München (DE)

(72) Inventors: Christian Schwemmer, Happurg (DE); Andreas Roßkopf, Nürnberg (DE); Andreas Erdmann, Erlangen (DE)

(21) Appl. No.: 19/352,868

(22) Filed: Oct. 8, 2025

(30) Foreign Application Priority Data
Oct. 10, 2024 (EP) 24205882.4

(51) Int. Cl. G01D 5/26

(52) U.S. Cl. CPC G01D 5/266

(57) ABSTRACT

The invention relates to a method for determining at least one corrective value for an actual phase value to be corrected and for determining a resulting phase value, which is determinable from a quadrature signal pair which comprises a first signal and another signal, comprising the steps:
a) Determining actual phase values specific to the sampling points for at least two sampling points, wherein the sampling points are respectively arranged spaced apart from each other by an integer multiple of a period length of the signals,
b) Determining an estimated curve of a phase value trajectory depending on the actual phase values specific to the sampling points,
c) Determining a target frequency distribution of phase values depending on the estimated curve,
d) Determining an actual frequency distribution of actual phase values.

The invention relates to a method and device for determining at least one corrective value for an actual phase value to be corrected and also for determining a resulting phase value.

Position or distance sensors, in particular interferometry-based or encoder-based sensors, generate output signals based on the so-called quadrature method, which is described in, e.g., U.S. Pat. No. 5,631,736 A, and also in the text, “J. Watchi, S. Cooper, B. Ding, C. M. Mow-Lowry, and C. Collette, Contributed Review: A review of compact interferometers, Review of Scientific Instruments 89 (12), 121501 (2018)”.

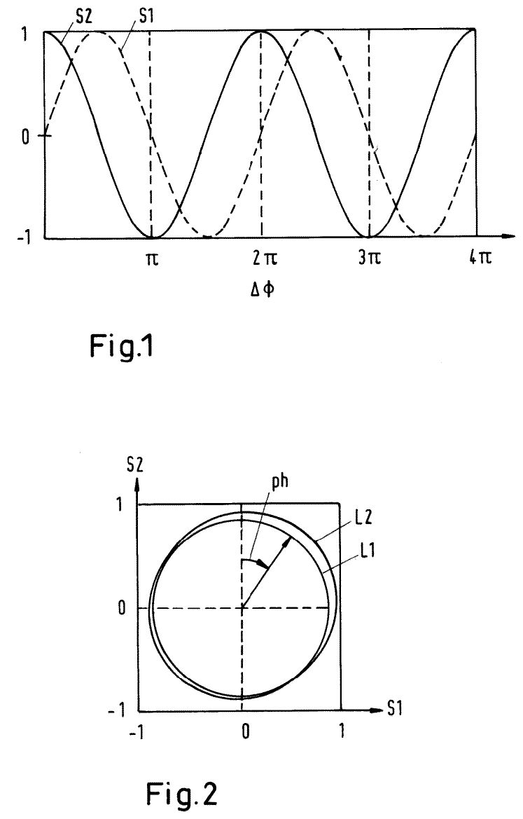

In the best case scenario, sinusoidal, normed signals, centered around zero and shifted 90° with respect to each other, are hereby generated, which form a so-called quadrature signal pair. If an amplitude value of a first signal of the pair forms an abscissa value (x value) and a corresponding amplitude value of another signal of this pairs forms an ordinate value (y value), then, in a best case scenario, the quadrature signal pair points lie in a circle over a period length of the signals, which is also known as a Lissajous figure, and is depicted in FIG. 2. Using the arctangent function, a period-specific phase value ph may then be determined as follows:

$$ph = arctan ( y / x ) . \qquad Formula 1$$

The period-specific phase value accepts values from a range of 0° to 360° or from 0 to 2π. An accumulated and non-period-specific phase value PH may be determined as follows:

$$PH = 2 π \times u + ph , \qquad Formula 3$$

where u represents the number of period runs already completely carried out.

This type of phase value ph, PH may correspond to a position value, which is assigned to the phase value. A change of the phase value ph, PH may also correspond to a change of the position value. Corresponding assignments may be determined, e.g., via a calibration. For example, this may be

$$Delta\_s = k \times Delta\_PH or k \times Delta\_ph , \qquad Formula 2$$

where Delta_s indicates a change of position and Delta_PH/Delta_ph indicates a change of phase value. The proportionality factor k may depend on different variables, e.g., a wavelength of the laser light used or the periodicity of an optical lattice used.

The problem with this method is that the Lissajous figure is not always ideally circular. The phase value ph, PH may then no longer be determined using the arctangent, or the accuracy of this type of determination is reduced. In particular, periodic measuring errors may occur in this case. In the case of interferometric sensors, the errors, under unfavorable circumstances, may be in a range greater than 10 nm, which may be too inaccurate, in particular for measurements in the semiconductor sector.

The causes of a non-circular Lissajous figure are numerous and include, among others, poorly matched detectors, multiple reflections in a measurement cavity, or also crosstalk between the measurement channels.

For the practically relevant, specific case of an elliptical Lissajous figure, there exist a plurality of corrective approaches, which, figuratively speaking, convert or transform the ellipsis into a circle. The approaches are usually variants or expansions of a method described in the text, “P. Heydemann, Determination and correction of quadrature fringe measurement errors in interferometers, Applied optics, 20 (19), 3382 (1981)”. However, these methods fail in the case of irregular, or in particular, non-elliptical Lissajous figures. These types of irregularly-shaped Lissajous figures occur, e.g., if a Fabry-Perot interferometer is used as a measurement cavity, and thus multiple reflections occur in the measurement arm, or if the quadrature signal pair is generated by modulating a laser wavelength using electricity, whereby an undesired yet inherent intensity modulation may occur.

The technical problem is therefore to create a method and a device for determining at least one corrective value for an actual phase value to be corrected and for determining a resulting phase value, which enable an exact determination of the resulting phase value. This should be possible, in particular in the case that the measured values (amplitudes) of a quadrature signal pair form an irregular Lissajous figure, thus are not arranged in a circular nor an elliptical line.

The solution to the technical problem arises from the subject matter having the features of the independent claims. Further advantageous configurations of the invention arise from the subclaims.

Proposed is a method for determining at least one corrective value for an actual phase value to be corrected. This actual phase value may encode or represent position information—as explained at the outset. In particular, changes in the actual phase value may represent or encode a change of position. Thus, a movement information may be determined depending on a change of the phase value, wherein this may comprise information about a movement direction and a path/angle covered. The actual phase value, as explained at the outset, is determinable from a quadrature signal pair or is determined from the quadrature signal pair. This quadrature signal pair comprises a first signal and another signal. At least one of these signals may be detected by a sensor or may be a measured signal. It is also conceivable that both signals are these types of measured signals. However, it is also conceivable that at least one of the signals is determined mathematically depending on a measured variable which is different from the signal. Ideally, the first signal is proportional to a sine function and the other signal is proportional to a cosine function. Known technologies for providing these types of quadrature signal pairs may include, e.g., the generation of phase-shifted signals using polarization degrees of freedom or a sinusoidal wavelength modulation. Ideally, the first and the other signal are then sinusoidal, normed signals, centered around zero and shifted 90° with respect to each other.

The proposed method comprises the following steps:

In a first determining step, actual phase values specific to the sampling points are determined for at least two sampling points, wherein the sampling points are respectively spaced apart from one another by a multiple of a period length of the signals. The signals have the same period length. The multiple is preferably 1; however it may also be greater than 1. In other words, an actual phase value is determined for multiple sampling points. These actual phase values specific to the sampling points may be stored, in particular in a storage device of a device for determining the at least one corrective value. It is hereby conceivable to store the actual phase values in a way assigned to the respective sampling point.

For example, a relative movement between a device for generating or providing the quadrature signal pair and a target may be carried out, wherein quadrature signal pairs are provided during this relative movement. As previously explained, the actual phase value determinable from the quadrature signal pair or its change may encode or represent movement information about the relative movement that was carried out.

Thus, actual phase values may be determined during the relative movement. Time information, which represents the time point of the generation, e.g., a time stamp, may be assigned to these actual phase values. It is possible to weight the actual phase values differently, e.g., depending on a time interval from the preceding and/or to the subsequent actual phase value. The actual phase values are preferably generated at a constant sampling rate and/or are identically weighted. Furthermore, the actual phase values may be generated over at least one predetermined number of periods, which may be, e.g., less than or greater than 10. The actual phase values specific to the sampling points may then be determined from the quantity of actual phase values determined in this way. The sampling point is preferably selected as a point, at which the arctangent function, explained at the outset, is 0 or has a maximum value or a minimum value. This advantageously allows for a simple and reliable determination of the sampling point.

In a second determining step, an estimated curve of a phase value trajectory is determined depending on the actual phase values specific to the sampling points. The estimated curve may also be designated as an estimated trajectory, and may, in particular, represent or approach a curve of the actual phase values over time during the explained relative movement. The estimated curve enables the determination of estimated phase values, which are not arranged at the previously explained sampling points. The estimated curve may be, in particular, a curve which minimizes deviations of the actual phase values specific to the sampling points from the corresponding estimated phase values of the estimated curve.

In a third determining step, a target frequency distribution of phase values is determined depending on the estimated curve. This target frequency distribution is preferably normed, in particular to the number of phase values which were determined over one or more period length(s). This may correspond to a probability density and may be a relative target frequency distribution. The target frequency distribution may thus be, in particular, the frequency distribution of the estimated phase values determined over one or more period length(s) of the signals. In particular, the target frequency distribution may be determined as a histogram, which is generated depending on estimated phase values, which were generated/determined from the estimated curve using a predetermined sampling rate. However, it is also conceivable to determine the target frequency distribution by applying a method for kernel density estimation or by processing the estimated curve using a suitably trained, machine learning model. The target frequency distribution determined in this way may also be designated as a theoretically expected distribution of phase values.

In a fourth determining step, an actual frequency distribution of phase values is determined. This actual frequency distribution is likewise normed, in particular to the number of phase values which were determined over one or more period length(s). This may likewise correspond to a probability density and may be a relative actual frequency distribution. This actual frequency distribution may also be designated as an experimentally observed frequency distribution, and is not determined depending on the estimated curve, but instead is determined depending on actual phase values, which were provided, in particular, by a corresponding device. As previously explained, actual phase values may be determined, e.g., using a predetermined sampling rate during a predetermined time period, wherein the actual frequency distribution is then determined as a histogram depending on these actual phase values. The actual frequency distribution may be, in particular, the frequency distribution of the actual phase values determined over one or more period length(s) of the signals. However, as previously, with respect to the theoretically expected frequency distribution, other methods for determining the actual frequency distribution may also be applied. The number of period lengths considered for the determination of the target and the actual frequency distribution is preferably identical; however, they may also be different. The sampling rate for determining the actual and the estimated phase values for determining the target and the actual frequency distribution is also preferably identical; however, they may also be different.

In a fifth determining step, a target phase value is determined for at least one selected actual phase value in such a way that the cumulative frequencies, specific to the phase values and determined based on the distributions, are identical. The target phase value may be a phase value of the estimated curve. To determine the cumulative frequencies specific to the actual or the target phase values, the frequencies, in particular those specified by the corresponding frequency distribution and which are assigned to different actual or estimated phase values, starting from a phase value of zero up to the actual or the estimated phase value, are cumulated. This may be carried out, for example, by summing up the frequency values specified by a histogram.

In this case, the target phase value is selected in such a way that the cumulative frequency specific to the target phase value specific is identical to the cumulative frequency specific to the actual phase value. This may be expressed mathematically as follows:

$${\int }_{0}^{{ϕ}_{true}} ρ ( {ϕ}^{′} ) d {ϕ}^{′} = {\int }_{0}^{{ϕ}_{N L}} {ρ}_{N L} ( {ϕ}^{′} ) d {ϕ}^{′} , \qquad Formula 1$$

where φₜᵣᵤₑ designates the target phase value and φ_{NL} designates the actual phase value. The variable ρ_{NL}
designates the (normed) actual frequency distribution and the variable ρ represents the (normed) target frequency distribution. By using the abbreviations

$${P}_{N L} ( {ϕ}_{N L} ) := {\int }_{0}^{{ϕ}_{N L}} {ρ}_{N L} ( {ϕ}^{′} ) d {ϕ}^{′} and P ( {ϕ}_{t r u e} ) := {\int }_{0}^{{ϕ}_{t r u e}} ρ ( {ϕ}^{′} ) d {ϕ}^{′} ,$$

formula 1 may be resolved by taking advantage of the strict monotony of P according to the target phase value:

$${ϕ}_{t r u e} = {P}^{- 1} ( {P}_{N L} ( {ϕ}_{N L} ) ) . \qquad Formula 2$$

The difference between the target and the actual phase value is then determined as a corrective value specific to the actual phase value. In other words, a corrective value specific to the actual phase value is thus determined. Furthermore, the corrective value specific to the actual phase value may be stored as previously explained.

Furthermore, the corrective value for the actual phase value to be corrected is determined depending on this corrective value specific to the actual phase value. Two scenarios may be distinguished in this case. If the actual phase value to be corrected is the selected actual phase value, or if it deviates from the same less than a predetermined amount, then the corrective value may be this corrective value specific to the actual phase value. However, if the actual phase value to be corrected differs from the selected actual phase value, in particular by more than a predetermined amount, then the corrective value may be determined, e.g., by interpolation depending on the corrective value specific to the actual phase value. This will be subsequently explained.

The proposed method advantageously enables a temporally fast and easy to implement determination of a corrective value for a specific actual phase value. It is particularly advantageous that this type of determination of the corrective value requires no prerequisites for the shape of the Lissajous figure as explained at the outset, like an elliptical shape, for example. An error correction for a broad application spectrum is thus enabled in an advantageous way. Furthermore, it advantageously arises that the proposed method, due to its simplicity, only places low demands on the hardware of a computing device to carry out the method. In particular, the method may be carried out on an integrated circuit, e.g. on a circuit implemented on an FPGA chip or integrated with the same, by which means, in particular, a fast implementation arises.

The proposed method may also comprise generating or providing and/or receiving the signals from quadrature signal pairs, wherein the actual phase values are determined from the signal values of the quadrature signal pairs.

In another embodiment, the estimated curve is determined by means of an interpolation. In the meaning of this invention, an interpolation may also comprise an extrapolation. Therefore, estimated phase values may thus be determined from the actual phase values specific to the sampling points by means of an interpolation. By this means, an easily implementable determination of the estimated curve may be advantageously enabled at a sufficient accuracy.

Alternatively, the estimated curve is determined by means of a Kalman filter. In this case, the actual phase values specific to the sampling points may be so-called observables. An estimated phase value may then be determined, in particular, as a system state variable, in particular before the application of a new observation. An accurate determination of the estimated curve thus advantageously arises from this.

Alternatively, the estimated curve is determined by means of a machine learning model. In this case, the quantity of actual phase values specific to the sampling points may form an input data point for the machine learning model, wherein the estimated curve, that is a quantity of estimated phase values, forms an output data point for the machine learning model. The machine learning model may be trained, in particular in multiple training steps, using suitable training data sets which comprise the training input data points and the training output data points. This type of training data set may be generated, in that an expert generates or specifies an estimated curve of estimated phase values as a training output data point for a quantity of actual phase values specific to the sampling points used as a training input data point. If, e.g., a target trajectory curve of a relative movement is already known, for example, because a calibration relative movement is carried out, then the estimated phase values may be determined depending on the target trajectory curve. This may also be designated as annotation. In the training phase, parameters, in particular weights and/or links, of the machine learning model may be adjusted in such a way that, in the machine learning model, a deviation between the output data points, generated by the machine learning model for the training input data points, deviates as little as possible from the training output data points. For this purpose, at least one parameter of the machine learning model may be changed in each training step. A machine learning model (MLM) may also be a model generated by a supervised learning process. This may be, in particular, a neural network, in particular a DL model, like a CNN (convolutional neural network), a RNN (recurrent neural network), a LSTM network (long short-term memory network) or a model from the transformer family (transformer model). However, it is also conceivable that a MLM was generated by an unsupervised learning process, a semi-supervised learning process, or a self-supervised learning process. A very accurate determination of the estimated curve advantageously thereby also arises, and a resulting, accurate determination of the corrective value.

In particular, such estimated phase values may thus be determined by means of interpolation, the Kalman filter, or the machine learning model, said estimated phase values are between the actual phase values specific to the sampling points, greater than a maximum actual phase value specific to the sampling points, or less than a minimum actual phase value specific to the sampling points.

In another embodiment, an actual phase value specific to the sampling points is determined depending on actual phase values specific to the scanning points, wherein the scanning points lie in a predetermined value range around the sampling point. To determine the actual phase values specific to the sampling points—as previously explained—the quadrature signal pair, and the corresponding current actual phase value arising therefrom, may be provided during a relative movement using a predetermined sampling rate. If none of these scanning points correspond to the (predetermined) sampling point, then the actual phase value specific to the sampling points may be determined depending on phase values specific to the scanning points, which were determined in a predetermined value range around the sampling point, for example as an average, in particular a weighted average. An accurate determination of the actual phase value specific to the sampling points advantageously arises thereby.

In another embodiment, a quality of the estimated curve is determined, wherein the determination of the target frequency distribution of phase values depending on the estimated curve is then only carried out if at least one predetermined quality criterion is satisfied. In particular, a quality metric depending on an estimated curve, determined in the second determining step, may be determined, wherein this metric represents a quality of the estimated curve, for example, an accuracy.

One possibility is to predict estimated phase values, in particular estimated phase values specific to the sampling points, based on the estimated curve, and to then compare the same with actually occurring actual phase values. Predicted estimated phase values may be those phase values that adjust, according to the estimated curve, during a further (future) continuation of the already explained relative movement. In particular, such predicted estimated phase values may be those estimated phase values that adjust in a predetermined predicted time period, for example, in a period-specific time period. The period-specific time period may hereby be a time period, which is required so that a period of the arctangent function, explained at the outset, may be run through and period-specific phase values may be generated.

The quality criterion may be satisfied, e.g., when a metric, which represents the deviations, is smaller than a predetermined amount. Correspondingly, the predetermined quality criterion may not be satisfied if this metric is equal to or greater than the predetermined amount. If the quality criterion is not satisfied, then the estimated curve may be determined once again. For this purpose, the second determining step in particular, yet also the sequence from the first and second determining steps, may be carried out once again.

An accurate determination of the estimated curve advantageously arises thereby, and thus an accurate determination of the corrective value.

In another embodiment, a deviation between the estimated curve, in particular a predicted estimated curve, and a measured curve is determined, wherein the quality criterion is satisfied if the deviation is smaller than a predetermined amount. This and corresponding advantages were already explained earlier.

In another embodiment, the quadrature signal pair is generated by means of an interferometric measuring system. The interferometric measuring system may be, in particular, a Michelson interferometer or a Fabry-Pérot interferometer. Naturally, however, other types of interferometric measuring systems may also be used. Alternatively, the quadrature signal pair is generated by means of an optical encoder. An optical encoder may comprise, e.g., a light source, one or more detector(s), and an optical lattice, wherein the detector(s) may be moved relative to the optical lattice, and the first and/or the other signal may be hereby generated and the quadrature signal may be thus provided. E.g., light, which is generated by the light source, may be radiated through or on to the optical lattice, which may be designed, e.g., from glass or plastic, wherein the optical lattice is configured in such a way that, in certain relative positions between the lattice and the detector(s), the light generated by the light source may be detected by the detector(s), and in other relative positions, it is blocked (and may not be detected). In both cases, a simple and reliable generation/provision of the quadrature signal pair advantageously arises. Thus, an accuracy of the information generated using the interferometric measuring system or the optical encoder, in particular movement information, may be advantageously increased.

In another embodiment, the corrective value is stored in a retrievable way and in a way assigned, in particular, to the selected or actual phase value to be corrected. In particular, the corrective value may be assigned to the period-specific phase values explained at the outset. If this (period-specific) actual phase value is determined (once again) at a later time, then the corresponding corrective value may be easily retrieved and may be used for correcting the actual phase value. There advantageously arises thereby a temporally fast and easily implementable correction of an actual phase value or an easily implementable and quickly renewed determination of the corresponding corrective value.

In another embodiment, according to the previously explained fifth determining step, corrective values are determined for each actual phase value of a set of phase values of at least two selected actual phase values as elements of a set of corrective values. In other words, corrective values specific to the actual phase values are thus determined as elements of a set of corrective values. Furthermore, a corrective value is determined, depending on the elements of the set of corrective values, thus the corrective values specific to the actual phase values, for an actual phase value to be corrected, which is not an element of this set of phase values. In particular, the corrective value may be determined, by means of an interpolation or by means of a Kalman filter or a machine learning model, for an actual phase value, which is not an element of the set of phase values, wherein reference is made to previous statements made regarding this. A temporally fast determination of a corrective value for an actual phase value may thereby be carried out, wherein this is sufficiently accurate and thus a sufficiently accurate corrected actual phase value may be determined. If the actual phase value to be corrected is an element of this set of phase values, then the corrective value assigned to the actual phase value in the set of phase values may be determined as the corrective value. These phase values of the set of phase values and the corrective values assigned to them may be stored in the form of a LUT (look up table).

In another embodiment, the corrective value, which is determined depending on the elements of the set of corrective values, is determined by means of an interpolation. This and corresponding advantages were already explained earlier.

The method is particularly suitable if at least one of the following assumptions applies:
1. Measurement errors are periodic, i.e., they repeat at each run through of a period or at a predetermined number, which may be, e.g., less than or equal to ten, of runs through a period.
2. A relative movement between a device for providing the quadrature signal pair or the actual phase values and a target may be described or represented by a trajectory, which is sufficiently smooth, in particular differentiable.
3. All actual phase values have a time stamp or are detected at known time points. The weighting of an individual measuring point is hereby proportional to the time interval of the preceding or subsequent actual phase value. Preferably, a constant sampling rate with equal weighting is used for all individual measurements.

Furthermore, a method is proposed for determining a resulting phase value of a quadrature signal pair that comprises a first signal and another signal. The resulting phase value may also be designated as a corrected phase value. This method comprises the steps:
a) Determining an actual phase value to be corrected,
b) Determining the resulting phase value by correcting the actual phase value to be corrected using a corrective value, which was determined using a method from one of the embodiments explained in this disclosure.

A very accurate determination of a resulting phase value is thereby advantageously enabled, in particular also for cases in which the Lissajous figure explained at the outset does not have a specific shape.

Furthermore, a device is proposed for determining at least one corrective value for an actual phase value to be corrected, which is determinable from a quadrature signal which comprises a first signal and another signal. The device comprises at least one first reception interface for receiving the quadrature signal pair, in particular for receiving the first and/or other signal, and an evaluation device. The evaluation device may be designed as a computing device. A computing device may be designed as a microcontroller or an integrated circuit, or may comprise one of the same. The device is configured to carry out a method for determining at least one corrective value for an actual phase value according to one of the embodiments explained in this disclosure. The previously explained advantages thereby result.

Furthermore, a device is proposed for determining at least one resulting phase value of a quadrature signal pair, which comprises a first signal and at least another signal, wherein this device comprises a device for determining at least one corrective value for an actual phase value according to one of the embodiments described in this disclosure, wherein the device for determining is configured to carry out a method for determining a resulting phase value according to one of the embodiments described in this disclosure. In particular, the correction of the actual phase value may be carried out using a corrective value by means of the evaluation device.

The device may be part of a path measuring device. The methods and the devices may be used in particular for/in applications, which require an accuracy of a path measurement that is less than or equal to one nanometer. For example, such methods/devices may be used in positioning systems for lithographic devices or may be components of such positioning systems. The path measurement may thereby be carried out in order to guarantee a position control during the movement of movable elements of such devices.

Furthermore, the proposed methods/devices may function for providing corrected measurement signals from interferometric measurement systems or optical encoders, or may be components of such systems/encoders.

Likewise, the proposed devices/methods may function for positioning monochromators for synchrotrons. They may also be used for vibration measurement or mass determination, e.g., by means of a watt balance.

If a positioning system enables a positioning along more than one axis, e.g., along 3, in particular multiple axes oriented at right angles to each other, then axis-specific path/position information may be determined depending on a resulting phase value determined for a specific axis. An axis-specific determination of corrective values, and thus an axis-specific determination of resulting phase values, may be carried out for each axis. This advantageously enables an accurate, axis-specific position measurement, as (periodic) errors for measuring axes are generally independent from one another and location-dependent.

The invention is explained in greater detail by way of exemplary embodiments. As shown in the figures:

FIG. 1 an exemplary curve of signals of a quadrature signal pair,

FIG. 2 an exemplary depiction of an ideal and a distorted Lissajous figure,

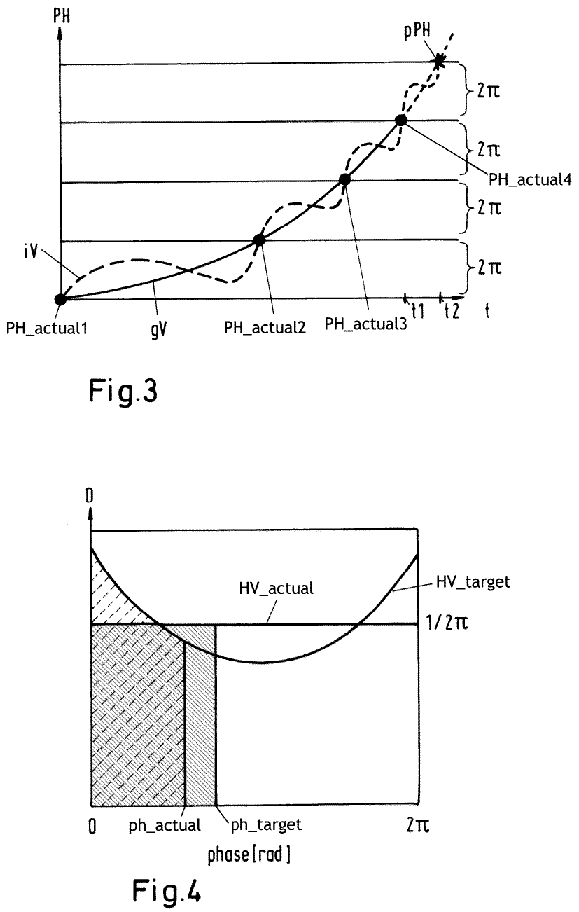

FIG. 3 a schematic depiction of actual phase values specific to the sampling points and an estimated curve,

FIG. 4 a schematic depiction of a target frequency distribution and an actual frequency distribution,

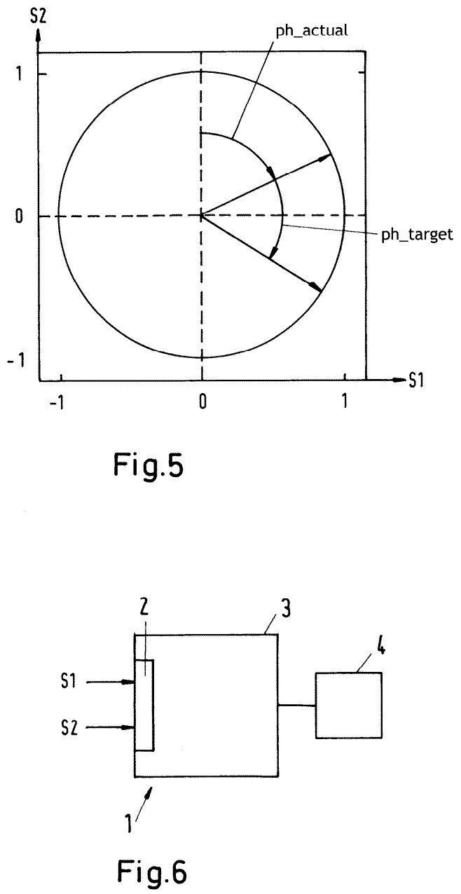

FIG. 5 a schematic depiction of a corrective value in a Lissajous diagram, and

FIG. 6 a schematic block diagram of a device according to the invention.

Identical reference numerals subsequently designate elements with identical or similar technical features.

FIG. 1 shows a schematic curve of a first signal S1 and another signal S2, which form a quadrature signal pair, and are generated, for example, by means of an interferometric measuring system or an optical encoder during a relative movement between a device for providing the signals S1, S2 and a target (neither is depicted). The curve of the two signals S1, S2 is depicted over different distances between the target and, e.g., one or more detector(s) of the device for providing, which provides the corresponding signals S1, S2. It is clear that the signals S1, S2 are sinusoidal, normed signals S1, S2, centered around zero and shifted 90° with respect to each other. A distance-specific quadrature signal pair comprises, as a first value, a distance-specific amplitude value of the first signal S1 and, as a second value, a distance-specific amplitude value of the second signal S2. If the amplitude values of the first signal S1 are applied as abscissa values and the (corresponding) amplitude values of the other signal S2 are applied as ordinate values, then the Lissajous figure, depicted in FIG. 2, results, wherein an ideal Lissajous figure L1 has a circular shape, in particular if the signals S1, S2 have the same amplitudes and no offset. In FIG. 2, a non-ideal Lissajous figure L2 is likewise depicted, which occurs, in particular, when periodic measuring errors arise. Furthermore, FIG. 2 depicts a period-specific actual phase value ph, which, as indicated in formula 1, is determined as an arctangent of the ratio of the amplitude value of the other signal S2 to the amplitude value of the first signal S1.

FIG. 3 shows a schematic curve of actual phase values PH_actual1, PH_actual2, PH_actual3, PH_actual4 specific to the sampling points. An actual curve IV of actual phase values PH_actual is depicted in the form of a dashed line, which actual phase values were determined using a predetermined sampling rate during a relative movement between a device for providing the quadrature signal pairs or the actual phase values PH_actual.

It is clear from FIG. 3, that the actual phase values PH_actual1, . . . , PH_actual4 specific to the sampling points are selected actual phase values PH_actual, which are generated during a relative movement over time. It is herein depicted that the actual phase values PH_actual1, . . . , PH_actual4 specific to the sampling points are respectively arranged spaced apart from each other by a period length 2π. The actual phase values PH_actual1, . . . , PH_actual4 specific to the sampling points may herein be determined and stored up to a first time point t1.

Furthermore, an estimated curve gV of a phase value trajectory is depicted by a solid line, which phase value trajectory was determined depending on the actual phase values PH_actual1, . . . , PH_actual4 specific to the sampling points, for example by means of an interpolation method. Thus, for example, estimated phase values specific to the scanning points of this estimated curve may be determined by interpolation depending on the actual phase values PH_actual1, . . . , PH_actual4 specific to the sampling points. In particular, for each or for selected scanning point(s) of the actual curve iV of actual phase values, a corresponding estimated phase value of the estimated curve may be determined. In other words, depending on the estimated curve gV, estimated phase values may be determined, which, using a predetermined sampling rate during a predetermined time period, adjust corresponding to the estimated curve. The predetermined time period may be, in particular, a time period, in which the scanning values are determined over an integer multiple of a period length of the signals according to the estimated curve gV. However, this is not mandatory.

A predicted estimated phase value pPH specific to the sampling points is also depicted in FIG. 3 and is likewise determined depending on the already determined actual phase values PH_actual1, . . . , PH_actual4 specific to the sampling points, for example, by means of an extrapolation. This predicted estimated phase value pPH functions for assessing a quality of the estimated curve gV. In particular, at another time point t2, which lies temporally after the first time point t1, the actual phase value specific to the sampling points may be determined and may be compared with the predicted estimated phase value pPH specific to the sampling points. If the value of the current actual phase value specific to the sampling points deviates by less than a predetermined amount from the value of the predicted, estimated phase value pPH specific to the sampling points, then a quality criterion is satisfied.

FIG. 4 shows a schematic depiction of frequency distributions, namely a target frequency distribution HV_target of phase values of the estimated curve gV (see FIG. 3), thus a frequency distribution of estimated phase values over a certain time period, in particular a period-specific time period, or a time period which corresponds to the sum of multiple period-specific time periods. FIG. 4 likewise shows an actual frequency distribution HV_actual of actual phase values during the same time period. These frequency distributions HV_target, HV_actual may be determined, for example, in that a histogram is generated across all sampling point specific values of the estimated curve gV, depicted in FIG. 3, and the actual curve iV, likewise depicted in FIG. 3, during the listed time period.

FIG. 4 additionally shows a period-specific actual phase value ph_actual, wherein the cumulated frequency specific to the actual phase value for this period-specific actual phase value ph_actual is visualized as a dashed, cross-hatched area under the actual frequency distribution from an actual phase value zero up to the period-specific actual phase value ph_actual. A period-specific target phase value ph_target and a corresponding cumulated frequency specific to the target phase value is likewise depicted in FIG. 4 as a solid, cross-hatched area under the target frequency distribution HV_target from an actual phase value zero up to the period-specific target phase value ph_target. The target phase value ph_target is herein determined in such a way that the described area under the target frequency distribution HV_target is identical to the described area under the actual frequency distribution HV_actual. In other words, the cumulated frequencies specific to the phase value are identical. The difference between the target phase value ph_target and the actual phase value ph_actual may then be determined as a corrective value.

It is possible to determine such a corrective value only for selected actual phase values, in particular selected, period-specific actual phase values, wherein corrective values for further actual phase values may then be determined depending on these corrective values. It is thus possible, for example, to determine corrective values for each actual phase value, in particular period-specific actual phase value, as an element of a set of corrective values, wherein, for a (n other) period-specific actual phase value, which is not an element of the set of phase values, a corrective value is determined depending on the elements of the set of corrective values, for example, by interpolation.

FIG. 5 shows the depiction, corresponding to FIG. 4, of the period-specific actual phase value ph_actual and the period-specific target phase value ph_target in the Lissajous figure. If a period-specific actual phase value ph_actual is determined according to formula 1, for example, because at least one of the signals S1, S2 is error-prone in comparison with an average value, then, using the proposed method, a target phase value ph_target may be determined which arises under the assumption of corresponding target signal values.

FIG. 6 shows a schematic block diagram of a device 1 for determining at least one corrective value for an actual phase value ph_actual (see FIG. 4) which is determinable from a quadrature signal pair, which comprises a first signal S1 and another signal S2. The device 1 comprises a reception interface 2 for receiving the quadrature signal pair, in particular the two signals S1, S2. The device 1 further comprises an evaluation device 3, wherein it is depicted that the reception interface 2 is part of the evaluation device 3. The actual phase value and the corresponding corrective value may be determined by means of the evaluation device 3. Likewise, using the evaluation device 3, a resulting phase value may be determined, in that an actual phase value ph_actual, determined from the signals S1, S2 is corrected using the corrective value.

A storage device 4 is likewise depicted in FIG. 6, wherein this storage device serves to store actual phase values PH_actual1, . . . , PH_actual4 specific to the sampling points and corrective values specific to the actual phase values. This thereby enables that the evaluation device 3 may determine an estimated curve gV (see FIG. 3) depending on the stored actual phase values PH_actual1, . . . , PH_actual4 specific to the sampling points. The evaluation device 3 may also determine corrective values depending on the corrective values specific to the actual phase values, which are stored in the storage device 4.

bestimmen.

### LIST OF REFERENCE NUMERALS

1 Device
2 Reception interface
3 Evaluation device
4 Storage device
gV Estimated curve
iV Actual curve
HV_actual Actual frequency distribution
HV_target Target frequency distribution
L1 Ideal Lissajous figure
L2 Non-ideal Lissajous figure
ph_actualActual phase value
ph_target Target phase value
PH_actual1, . . . , PH_actual4 Actual phase values
pPH Predicted estimated phase value specific to the sampling point
S1 First signal
S2 Other signal
t1 First time point
t2 Other time point

1. A method for determining at least one corrective value for an actual phase value to be corrected, which is determinable from a quadrature signal pair which comprises a first signal and another signal, comprising the steps:
a) Determining actual phase values specific to the sampling points for at least two sampling points, wherein the sampling points are respectively arranged spaced apart from each other by an integer multiple of a period length of the signals,
b) Determining an estimated curve of a phase value trajectory depending on the actual phase values specific to the sampling points,
c) Determining a target frequency distribution of phase values depending on the estimated curve, and
d) Determining an actual frequency distribution of actual phase values,
e) wherein for at least one selected actual phase value, a target phase value is determined in such a way that the cumulative frequencies specific to the phase values, determined based on the distributions, are identical, wherein the difference between the target and the actual phase value is determined as a corrective value specific to the actual phase value, wherein the corrective value is determined depending on this corrective value specific to the actual phase value.

2. The method according to claim 1, wherein the estimated curve is determined by means of an interpolation or by means of a Kalman filter or a machine learning model.

3. The method according claim 1, wherein an actual phase values specific to the sampling points is determined depending on actual phase values specific to the scanning points, wherein the scamming points lie in a predetermined value range around the sampling point.

4. The method according to claim 1, wherein a quality of the estimated curve is determined, wherein the determination of the target frequency distribution of phase values depending on the estimated curve is then only carried out if at least one predetermined quality criterion is satisfied.

5. The method according to claim 4, wherein a deviation between the estimated curve and a measured curve is determined, wherein the quality criterion is satisfied if the deviation is less than a predetermined amount.

6. The method according to claim 1, wherein the quadrature signal pair is generated by means of an interferometric measuring system or an optical encoder.

7. The method according to claim 1, wherein the corrective value is stored in a retrievable way and in a way assigned to the actual phase value.

8. The method according to claim 1, wherein corrective values for each selected actual phase value of a set of phase values of at least two actual phase values are determined according to step e) as elements of a set of corrective values, wherein a corrective value is determined, depending on the elements of the set of corrective values, for an actual phase value to be corrected which is not an element of the set of phase values.

9. The method according to claim 8, wherein the corrective value, which is determined depending on the elements of the set of corrective values, is determined by means of an interpolation.

10. A method for determining a resulting phase value of a quadrature signal pair which comprises a first signal and another signal, comprising the steps:
a) Determining an actual phase value to be corrected,
b) Determining the resulting phase value by correcting the actual phase value to be corrected using a corrective value, which was determined using a method according to claim 1.

11. A device for determining at least one corrective value for an actual phase value to be corrected, which is determinable from a quadrature signal pair which comprises a first signal and another signal, wherein the device comprises at least one reception interface for receiving the quadrature signal pair and an evaluation device, wherein the device is configured to carry out a method according to claim 1.

12. A device for determining at least one resulting phase value of a quadrature signal pair which comprises a first signal and another signal, comprising a device according to claim 11.

13. A device for determining at least one resulting phase value of a quadrature signal pair which comprises a first signal and another signal, wherein the device is configured to carry out a method according to claim 10.
